(19) United States
(12) Patent Application Publication
(10) Pub. No.: US 2025/0330806 A1
(43) Pub. Date: Oct. 23, 2025

(54) PREVENTING MESSAGE QUEUEING OF A SECURITY PROTOCOL BY AN ATTACKER

(71) Applicant: Cypress Semiconductor Corporation, San Jose, CA (US)

(72) Inventors: Yi-Chuan Chen, HsinChu County (TW); Po-Hsuan Huang, HsinChu County (TW)

(73) Assignee: Cypress Semiconductor Corporation, San Jose, CA (US)

(21) Appl. No.: 18/642,277

(22) Filed: Apr. 22, 2024

(51) Int. Cl. H04W 12/037; H04W 12/0471

(52) U.S. Cl. CPC H04W 12/037; H04W 12/0471

(57) ABSTRACT

Methods and systems for preventing message queueing of a security protocol by an attacker. The disclosed method includes, among other things, initiating a security protocol to establish secure communication between the first station device and the AP device, receiving, prior to or during an exchange of messages associated with the security protocol, one or more first frames identifying a media access control (MAC) address of the first station device, and responsive to determining that the power management bit of the one or more first frames indicates that the first station device is in the power saving mode, proceeding with the exchange of messages associated with the security protocol.

### TECHNICAL FIELD

This disclosure relates to access point devices, and, more specifically, to preventing message queueing of a security protocol by an attacker.

### BACKGROUND

Access point devices in wireless networks play a crucial role in enabling wireless communication between a variety of client devices, also known as stations devices. They serve as vital bridges between these stations and a wired network, typically based on Ethernet. Secure communication is essential for protecting data in wireless networks, which are more vulnerable to attacks. Encryption makes it difficult for attackers to intercept and read transmitted data, even if they capture it.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram of an exemplary illustration of a wireless network that has an access point device and one or more station devices, in accordance with implementations of the present disclosure.

FIG. 2 illustrates a set of interactions between one or more station devices in the wireless network and the access point device in the wireless network, in accordance with implementations of the present disclosure.

FIG. 3 is a block diagram of an exemplary illustration of a frame used to modify the power management mode of a station device of the wireless network, in accordance with implementations of the present disclosure.

FIG. 4 depicts a flow diagram of an example method for preventing message queueing of a security protocol by an attacker, in accordance with implementations of the present disclosure.

### DETAILED DESCRIPTION

Aspects of the present disclosure relate to preventing message queueing of a security protocol by an attacker. An access point (AP) is designed to facilitate wireless connectivity for a variety of client devices, also known as stations devices. Station devices establish a connection with the AP through a process called association. The station device scans a radio frequency spectrum for available APs. The station device sends a probe request frame to each AP it detects. The APs respond with probe response frames that contain information such as the APs' service set identifier (SSID), basic service set identifier (BSSID), and supported data rates. The station device selects an AP to connect to based on factors such as signal strength, SSID, and security settings. The station device sends an association request frame to the selected AP. The AP responds with an association response frame, indicating whether the association is successful. If the association is successful, the station device and AP exchange authentication credentials. Once the authentication is complete, a connection is established between the station device and AP to begin communicating with each other.

Typically, the connection established between the station device and AP is not secure. Thus, a security protocol, such as, a 4-way handshake is initiated to establish a secure connection between the station device and AP. It is part of the WPA2 and WPA3 security standards. The 4-way handshake works via a key exchange process that exchanges messages (e.g., four extensible authentication protocol over local area network (EAPOL) messages) between the station device and the AP to derive encryption keys used to secure data transmissions over the connection. In other words, the messages that are exchanged are extensible authentication protocol over local area network (EAPOL) messages to derive encryption keys used to secure data transmissions over the connection. These messages contain information such as the nonce values, the Pairwise Master Key (PMK), and the Group Temporal Key (GTK). The PMK is a shared secret key that is used to generate the GTK. The GTK is a temporary key that is used to encrypt and decrypt data traffic between the station device and the AP. The 4-way handshake ensures that the PMK is never sent over the air in plain text. This makes it very difficult for attackers to intercept and interpret the PMK. Once the 4-way handshake is complete, the station device and the AP can communicate with each other securely (i.e., communication is secure so that attackers cannot intercept and modify the traffic).

Attackers are individuals or groups who attempt to gain unauthorized access to computer systems, networks, or data. Attackers often scan networks for systems with known vulnerabilities and then exploit those vulnerabilities (or weaknesses) to gain access. In recent times, attackers have been exploiting a vulnerability in the way that 802.11 access points manage transmit queues. After association, attackers send a series of specially crafted frames (e.g., null frames), also known as spoofing, and sets a sleep-bit in the frame header of the null frames. The AP, in response, marks the station device as asleep. The AP will now queue all bufferable frames, including the first 4-way handshake message (which is sent as a data frame). This leads to a handshake timeout at both the AP and the station device, since the first 4-way handshake message was never sent. The station device never receives the first 4-way handshake message, causing a timeout. The timeout results in termination of the 4-way handshake. The station device, in response to termination of the 4-way handshake, sends a de-authentication message to the AP. The AP, still buffering frames, fails to send a de-authentication message back to the station device. The station device, in response, times out and disconnects from the network. This form of attack is also known as “queuing-based denial-of-service attack”.

Aspects and embodiments of the present disclosure address these and other limitations of the existing technology by establishing a connection between the station device and an AP device or a station device configured to operate as an AP (e.g., a software AP or Soft AP) (herein referred to as “AP”). Once the connection is established, disabling acknowledgment of null frames identifies the station device. For example, the null frame may be received by the station device or any other station device, such as an attacker. A security protocol may be initiated to establish a secure connection between the station device and the AP. In some embodiments, the station device and/or attacker may transmit a null frame to the AP to change the power management mode of the station device (e.g., from active mode to power save mode). Active mode indicates that the station device can receive and transmit frames at any time. Power save mode indicates that the station device can enter an awake state to receive and transmit frames when necessary. The AP ignores the null frame and proceeds with the key exchange process of the security protocol. Once the key exchange process of the security protocol is complete and a secure connection is established between the station device and AP, the AP may enable acknowledgment of null frames identifying the station device. Accordingly, the AP transmits in response to the null frame (from the station device and/or attacker) identifying the station device an acknowledgment frame to allow the station device to change its power management mode (e.g., from active mode to power save mode).

Aspects of the present disclosure overcome these deficiencies and others by preventing the queueing of messages of the security protocol, thereby preventing attackers from forcing disconnection of the station device.

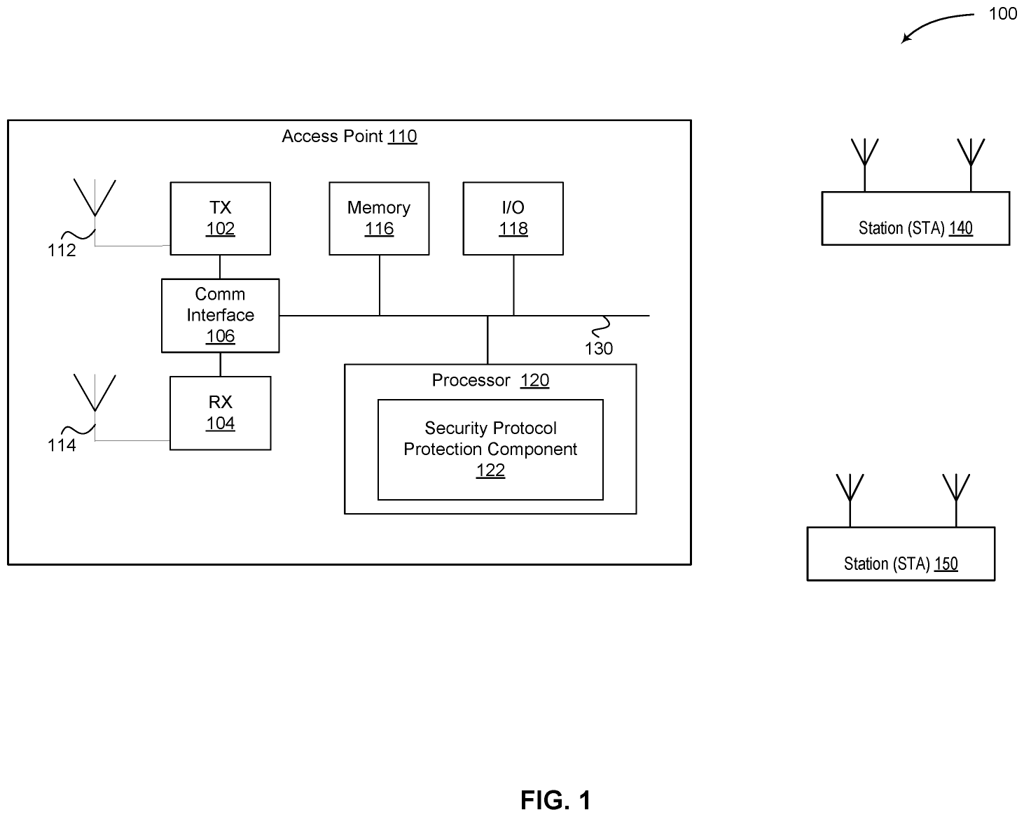

FIG. 1 is a block diagram of an exemplary illustration of a wireless network 100 that has one or more station devices, in accordance with implementations of the present disclosure. The wireless network 100 may be a wireless local area network (WLAN), wireless wide area network (WWAN), wireless metropolitan area network (WMAN), wireless personal area network (PAN), and so on. The wireless network 100 may include a station device (STA) operating as an access point 110. The wireless network 100 may include one or more client devices, such as station device (STA) 140 and station device (STA) 150. STA 140 and/or STA 150 may establish a wireless connection with the AP 110. The wireless connection provided by AP 110 may use any bands, such as the 2.4 GHz regulatory domain, the 5 GHz domain, the 60 GHz domain, the 6 GHz domain, or any other frequency band.

In at least some embodiments, AP 110 includes, but is not limited to, a transmitter 102 (e.g., a PAN transmitter), a receiver 104 (e.g., a PAN receiver), a communications interface 106, a transmitter (TX) antenna 112 coupled to the transmitter 102, a receiver (RX) antenna 114 coupled to the receiver 104, a memory 116, one or more input/output (I/O) devices 118 (such as a display screen, a touch screen, a keypad, and the like), and a processor 120. These components can all be coupled to a communications bus 130. In some embodiments, aspects of the communication interface 106 work with the processor 120 to perform operations or functions as a processing device of the AP 110. In some embodiments, there is a single antenna and multiplexing logic to switch the use of the antenna between the transmitter 102 and receiver 104. In various embodiments, front end components such as the transmitter 102, the receiver 104, the communication interface 106, and the one or more antennas (e.g., TX antenna 112 and/or RX antenna 114) described herein within various devices are adapted with or configured for WLAN and PAN-based frequency bands, e.g., Bluetooth® (BT), BLE, Wi-Fi™, Zigbee®, Z-Wave™, and the like.

Processor 120 may include a security protocol protection component 122. In response to determining that a connection is established between the STA 140 and the AP 110, security protocol protection component 122 initiates a security protocol to secure the established connection between the STA 140 and the AP 110. The connection is established in response to the security protocol protection component 122 determining that an authentication request frame and an association request frame was received from STA 140 and a corresponding authentication response frame and association response frame were transmitted back to STA 140. Once the connection is established between the STA 140 and the AP 110, security protocol protection component 122 may initiate the security protocol. As previously described, the security protocol, such as 4-way handshake involves exchanging four messages between the STA 140 and the AP 110. Once the 4-way handshake is complete, the STA 140 and the AP 110 can communicate with each other securely (i.e., communication is secure so that attackers cannot intercept and modify the traffic).

In some embodiments, prior to initiation of the security protocol, security protocol protection component 122 may determine that the AP 110 received a null frame identifying a station device (e.g., STA 140). As previously described, a null frame provides bits to indicate a power management mode of the station device (e.g., STA 140). Power management mode may be an active mode, or a power save mode. Active mode indicates that the station device (e.g., STA 140) is in an awake state. An awake state indicates that the station device (e.g., STA 140) can receive and transmit frames at any time. Power save mode indicates that the station device (e.g., STA 140) is in a sleep state. A sleep state indicates that the station device (e.g., STA 140) can enter an awake state to receive and transmit frames when necessary.

Security protocol protection component 122 may determine whether the security protocol was completed. Security protocol protection component 122 determines whether the security protocol was complete. Since the security protocol was not initiated, and therefore could not be completed, the security protocol protection component 122 forces the completion of the security protocol (i.e., proceeds with the security protocol rather than responding with an acknowledgment frame). An acknowledgment (ACK) frame is a frame used to acknowledge the receipt of a frame. The ACK frame is utilized by the station device indicated in the null frame to change the power management mode according to a bit in the null frame.

More specifically, the station device (e.g., STA 140) in connection with the AP 110 that changes power management mode shall inform the AP 110 of this fact using a certain portion of the frame (e.g., a power management field of the frame). The station device (e.g., STA 140) shall remain in its current power management mode until it informs the AP 110 of the power management mode change via the frame exchange that includes acknowledgment from the AP 110. Power management mode shall not change until the acknowledgment is received from the AP 110.

In some embodiments, prior to completion of the security protocol, security protocol protection component 122 may determine that the AP 110 received a null frame identifying a station device (e.g., STA 140). In a similar manner as previously described, the security protocol protection component 122 determines whether the security protocol is complete. If the security protocol protection component 122 determines that the security protocol is not completed, security protocol protection component 122 forces the completion of the security protocol (i.e., proceeds with the security protocol rather than responding with an acknowledgment frame).

In some embodiments, after completion of the security protocol, security protocol protection component 122 may determine that the AP 110 received a null frame identifying a station device (e.g., STA 140). The security protocol protection component 122 determines whether the security protocol is complete. If the security protocol protection component 122 determines that the security protocol is completed, security protocol protection component 122 transmits an acknowledgment frame identifying the station device (e.g., STA 140) identified in the received null frame. The station device (e.g., STA 140) may change its power management mode as a result of the ACK frame. Thus, for any null frame identifying the station device (e.g., STA 140) that is received after the completion of the security protocol, a corresponding ACK frame may be transmitted in response.

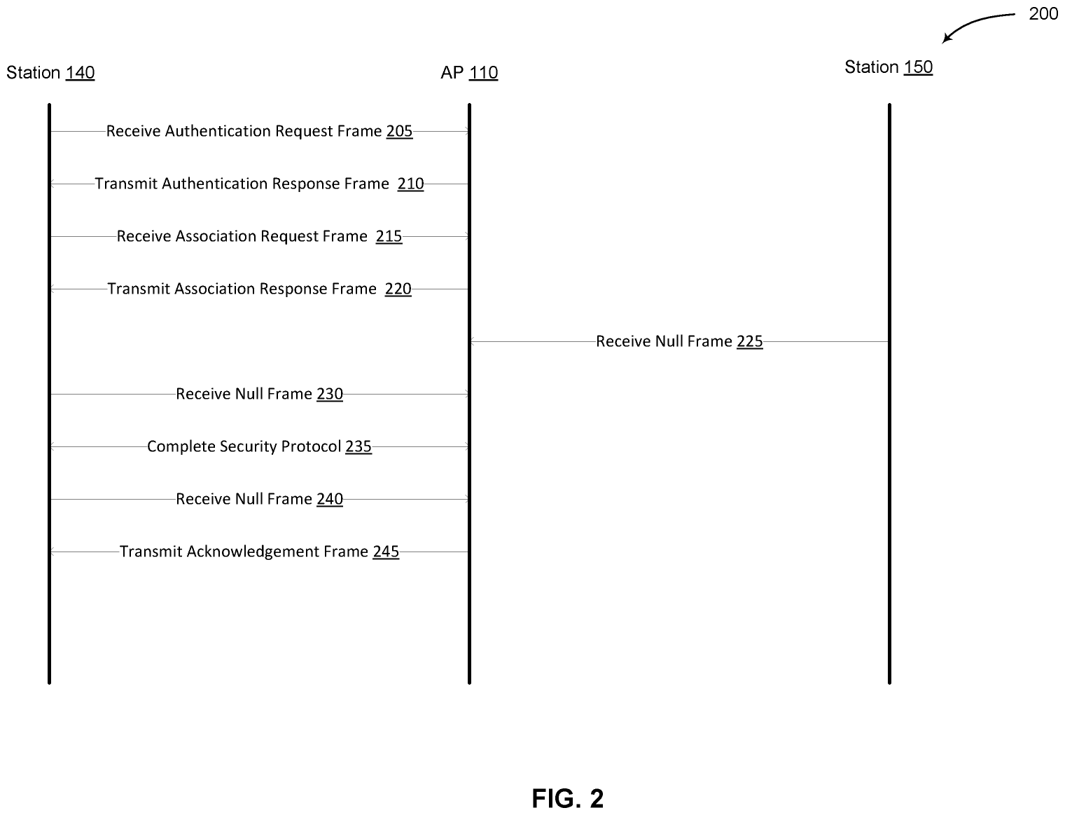

FIG. 2 illustrates a set of interactions between one or more station devices in the wireless network and the access point device in the wireless network 200, in accordance with implementations of the present disclosure. The wireless network 200, similar to wireless network 100, includes AP 110, station device (STA) 140, and station device (STA) 150.

Prior to interaction 205, STA 140 may send a probe request to discover nearby APs (e.g., AP 110). In response, any AP (e.g., AP 110) within range of STA 140 sends out beacon frames to advertise their presence and network capabilities. These beacon frames contain information such as the network's SSID (Service Set Identifier), supported data rates, supported security mechanisms (including AKM suites), and other network parameters. The AKM suites defines various methods and protocols used for authentication and key management during the connection establishment. For example, the AKM suites can include WPA-PSK (Pre-Shared Key), WPA2-PSK, WPA-Enterprise (using EAP authentication methods like EAP-TLS, EAP-TTLS, PEAP, etc.), and others. The STA 140 receiving the beacon frames can analyze this information to decide which network to connect to and what security mechanism to use.

At interaction 205, AP 110 receives an authentication request frame from STA 140. Authentication request frame is a frame used in wireless networks to initiate the authentication process. It is sent by a station device (e.g., STA 140) to an access point (e.g., AP 110) and contains information about the station device, such as its MAC address. At interaction 210, AP 110 transmits to STA 140 an authentication response frame. Authentication response frame is a frame sent in response to receiving the authentication request frame which contains information required for the authentication process to complete. Once the authentication response frame is transmitted to STA 140 from the AP 110, the STA is authenticated with the AP 110.

At interaction 215, AP 110 receives an association request frame from the STA 140. Association request frame is a frame used in wireless networks by a station device (e.g., STA 140) to request association with an access point (e.g., AP 110) and includes information about its own capabilities, including the AKM methods it supports and is going to be used to connect to AP 110. It is sent after the STA has successfully authenticated with the AP 110. At interaction 220, AP 110 transmits an association response frame from STA 140. Association response frame is a frame sent in response to receiving the association request frame and includes a status code indicating that the AKM of STA 140 is accepted or not. Once the association response frame is transmitted to STA 140 from the AP 110, the STA is associated with the AP 110 and data frames can be exchanged between with the STA 140 and the AP 110. Additionally, AP 110 can anticipate a security protocol, such as a 4-way handshake, based on the AKM used by STA 140. In some embodiments, AP 110, via a link layer, can set the state machine to a state in which the STA is authenticated and unsecured (i.e., the port is blocked and not secured yet). Accordingly, AP 110 disables acknowledgement until the port is secured.

At interaction 225, AP 110 receives a null frame from STA 150. Null frame is a frame used in wireless networks to send control information without any data payload. Null frames are typically used to indicate a power management mode of a station device identified in the frame. In particular, STA 150, which may be an attacker, generated the null frame indicating that a power management mode of STA 140 is in sleep state. STA 150 transmitted the null frame to the AP 110. In response to receiving the null frame by the AP 110, the AP 110 determines that the frame is directed to changing a power management mode of STA 140. The null frame was transmitted to the AP 110 without knowledge of the actual transmitter (e.g., STA 150). AP 110 ignores the null frame by not sending an acknowledgment frame and proceeding with the exchange of messages of the security protocol. Acknowledgment frame is a frame used in wireless network to acknowledge the receipt of the recently received frame.

At interaction 230, AP 110 receives a null frame from STA 140. In particular, STA 140, which may be interested in changing its power management mode, generated the null frame indicating that the power management mode of STA 140 is in sleep state. STA 140 transmitted the null frame to the AP 110. AP 110 receiving the null frame determines that the frame is directed to changing a power management mode of STA 140. AP 110 ignores the null frame by not sending an acknowledgment frame and proceeding with the exchange of messages of the security protocol.

At interaction 235, security protocol is completed between the AP 110 and STA 140. Initiation and completion of security protocol, for example, 4-way handshake consists of four messages exchanged between the AP 110 and STA 140 after authentication and association. Once the handshake is complete, the AP 110 and STA 140 have successfully established a secure connection and can exchange data in a secure manner. At interaction 240, AP 110 receives a null frame from STA 140. At interaction 245, AP 110 transmits an acknowledgment frame from STA 140. Accordingly, any null frame received indicating a power management change of STA 140 after interaction 235 is acknowledged (or not ignored).

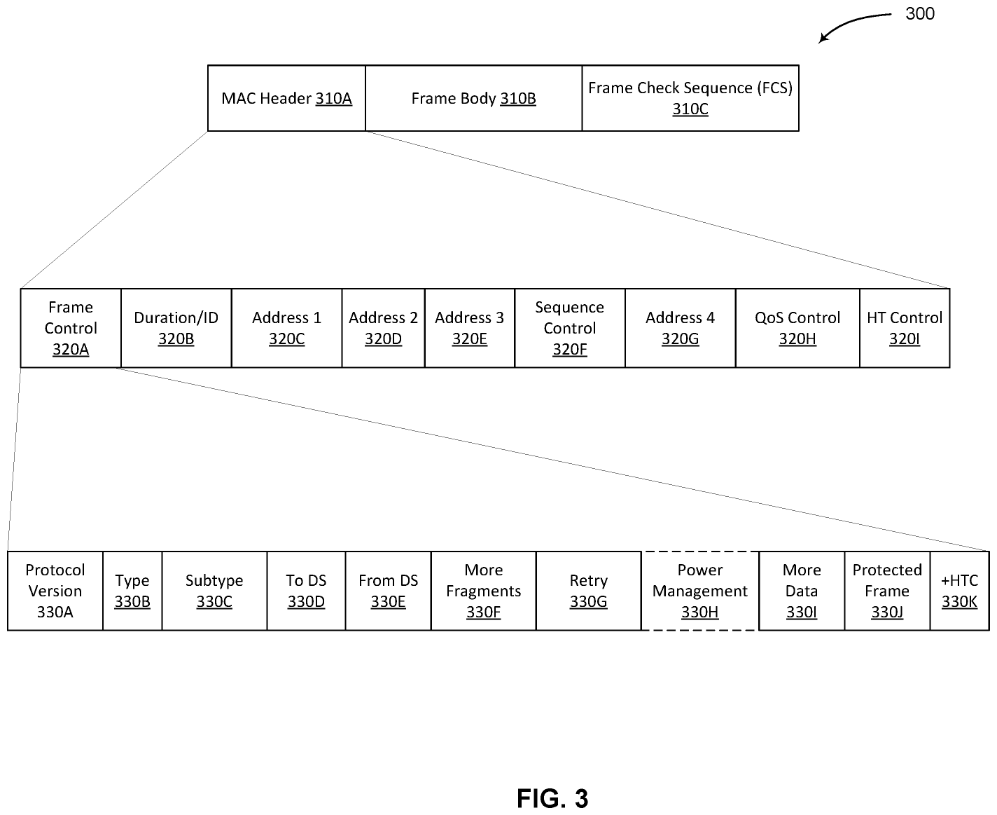

FIG. 3 illustrates a frame 300 used to modify the power management mode of a station device of the wireless network, in accordance with implementations of the present disclosure. Frame 300 includes a frame body 310B and a frame check sequence (FCS) 310C. Frame 300 may include a media access control (MAC) header 310A. MAC header 310A includes a duration 320B, address 1 320C, address 2 320D, address 3 320E, sequence control 320F, address 4 320G, quality of service (QOS) control 320H, high throughput (HT) control 320I. MAC header 310A may further include a frame control 320A which includes protocol version 330A, type 330B, subtype 330C, to distribution system (DS) 330D, from DS 330E, more fragments 330F, retry 330G, more data 330I, protected frame 330J, and high throughput control (+HTC) 330K.

Frame control 320A may further include a power management 330H. Power management 330H refers to one or more bits that indicate a power management mode of the identified STA. The one or more bits of power management 330H may be set to indicate that a STA is in power save (PS) mode (or sleep state) and cleared to indicate that the STA is active mode (or awake state). During active mode, the STA may receive and transmit frames at any time. During PS mode, the STA remains in sleep state and may enter the awake state to receive or transmit frames when necessary.

According to the 802.11 specification, the STA remains in a current mode (e.g., active mode) until the STA informs the AP of the power management mode change via a frame 300. Frame 300 (e.g., a null frame) is a frame notifying the AP of the power management mode change from the current mode (e.g., active mode) to another mode (e.g., PS mode). In order to notify the AP of the power management mode change the one or more bits of power management 330H in the null frame (e.g., frame 300) is set (for PS mode) or cleared (for active mode). An acknowledgment frame may be received by the STA indicating that the AP acknowledges and accepts the request for the power management mode change indicated in the null frame (e.g., frame 300). The power management mode should not change until the acknowledgment frame is received in response to the null frame. Additionally, the AP must queue packets to be sent to the STA after receiving a null frame of the frame exchange indicating that the power management mode is in PS mode.

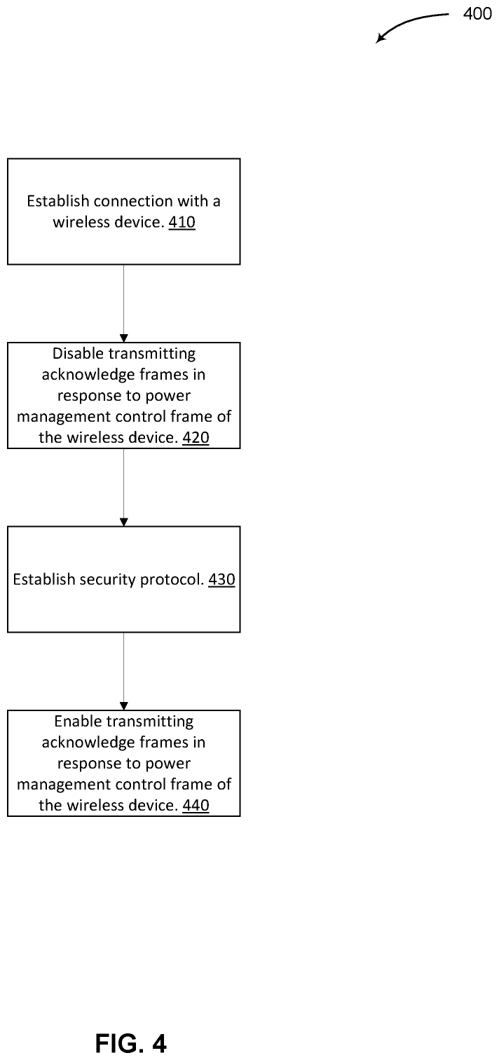

FIG. 4 is a flow diagram of a method 400 of preventing message queueing of a security protocol by an attacker, in accordance with implementations of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the AP 110, including the channel selection component 122 and/or the application processor 120 (e.g., processing device).

At operation 410, the processing logic establishes a connection with a station device. In particular, the AP (110) receives an authentication request frame (205) and transmits, in response, an authentication response frame (210) to the station device (140). The AP (110) further receives an association request frame (215) and transmits, in response, an association response frame (220) to the station device (14). Once the authentication and association are complete, the connection is established. Thus, a security protocol (e.g., 4-way handshake) may be used to establish a secure connection between the station device and the AP (110). The security protocol exchanges messages (e.g., four messages) between the station device and the AP (110). These messages contain information such as the nonce values, the Pairwise Master Key (PMK), and the Group Temporal Key (GTK). The PMK is a shared secret key that is used to generate the GTK. The GTK is a temporary key that is used to encrypt and decrypt data traffic between the station device and the AP (110).

At operation 420, the processing logic disables transmitting acknowledgment frames in response to power management control frame of the station device (i.e., a null frame identifying the station device). More specifically, in response to establishing the connection between the station device and the AP (110), the AP (110) disables acknowledging the null frames identifying the station device. As previously described the AP (110) disables acknowledging the null frames by changing the state machine of the AP 110 to authenticated and unsecured. Accordingly, in the event that the AP (110) receives a null frame (225 or 230) from the station device (140) or another station device (150), such as an attacker, the AP (110) ignores the null frame by not transmitting acknowledgment frames. As a result, the station device is unable to change its power management mode. Thus, the station device (140) remains in active mode to ensure the completion of the security protocol (i.e., the AP (110) proceeds with the exchange of messages associated with the security protocol).

At operation 430, the processing logic establishes the security protocol. The security protocol is established once all messages are exchanged (e.g., the four messages) between the station device and the AP (110). The established security protocol provides the secure connection between the station device and the AP (110).

At operation 440, the processing logic enables transmitting acknowledgment frames in response to power management control frame of the station device (i.e., a null frame identifying the station device). More specifically, in response to establishing the secure connection between the station device and the AP (110), the AP (110) enables acknowledging the null frames identifying the station device. Accordingly, in the event that the AP (110) receives a null frame (240) from the station device (140) or another station device (150), such as an attacker, the AP (110) acknowledges the null frame by transmitting acknowledgment frames (245). As a result, the station device can change its power management mode and the attacker is unable to intercept and/or modify the traffic.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
responsive to receiving a request, by an access point (AP), to establish a connection with a first station device, initiating a security protocol to establish secure communication between the first station device and the AP;
receiving, prior to or during an exchange of messages associated with the security protocol, one or more first frames identifying a media access control (MAC) address of the first station device;
determining whether a power management bit of the one or more first frames indicates that the first station device identified by the MAC address is in a power saving mode; and
responsive to determining that the power management bit of the one or more first frames indicates that the first station device is in the power saving mode, proceeding with the exchange of messages associated with the security protocol.

2. The method of claim 1, further comprising:
receiving, after completion of the exchange of messages associated with the security protocol, one or more second frames identifying the MAC address of the first station device;
determining whether a power management bit of the one or more second frames indicates that the first station device identified by the MAC address is in a power saving mode; and
responsive to determining that the power management bit of the one or more second frames indicates that the first station device is in the power saving mode, transmitting an acknowledgment frame to the first station device.

3. The method of claim 1, wherein the security protocol comprises a key exchange process.

4. The method of claim 1, wherein the one or more first frames is received from the first station device or a second station device.

5. The method of claim 1, wherein the mode associated with the power management bit indicates an active mode or a power saving mode, and wherein setting the power management bit indicates that the first station device identified by the MAC address is in power saving mode and clearing the power management bit indicates that the first station device identified by the MAC address is in active mode.

6. The method of claim 1, wherein the request to establish the connection with the first station device includes receiving an authentication request frame and an association request frame from the first station device.

7. The method of claim 1, wherein the messages that are exchanged are extensible authentication protocol over local area network (EAPOL) messages to derive encryption keys used to secure data transmissions over the connection.

8. An access point (AP) device, comprising:
a processor, wherein the processor is to perform operations comprising:
responsive to receiving a request, by the AP device, to establish a connection with a first station device, initiating a security protocol to establish secure communication between the first station device and the AP;
receiving, prior to or during an exchange of messages associated with the security protocol, one or more first frames identifying a media access control (MAC) address of the first station device;
determining whether a power management bit of the one or more first frames indicates that the first station device identified by the MAC address is in a power saving mode; and
responsive to determining that the power management bit of the one or more first frames indicates that the first station device is in the power saving mode, proceeding with the exchange of messages associated with the security protocol.

9. The AP device of claim 8, wherein the processor is to perform operations further comprising:
receiving, after completion of the exchange of messages associated with the security protocol, one or more second frames identifying the MAC address of the first station device;
determining whether a power management bit of the one or more second frames indicates that the first station device identified by the MAC address is in a power saving mode; and
responsive to determining that the power management bit of the one or more second frames indicates that the first station device is in the power saving mode, transmitting an acknowledgment frame to the first station device.

10. The AP device of claim 8, wherein the security protocol is a key exchange process.

11. The AP device of claim 8, wherein the one or more first frames is received from the first station device or a second station device.

12. The AP device of claim 8, wherein the power management bit indicates an active mode or a power saving mode, and wherein setting the power management bit indicates that the first station device identified by the MAC address is in power saving mode and clearing the power management bit indicates that the first station device identified by the MAC address is in active mode.

13. The AP device of claim 8, wherein the request to establish the connection with the first station device includes receiving an authentication request frame and an association request frame from the first station device.

14. The AP device of claim 8, wherein the messages that are exchanged are extensible authentication protocol over local area network (EAPOL) messages to derive encryption keys used to secure data transmissions over the connection.

15. A wireless network comprising:
a first station device;
a second station device; and
a third station device operating as an access point (AP), wherein a processor of the third station device is to perform operations comprising:
responsive to receiving a request, by the AP, to establish a connection with the first station device, initiating a security protocol to establish secure communication between the first station device and the AP;
receiving, prior to or during an exchange of messages associated with the security protocol, a first frame identifying a media access control (MAC) address of the first station device;
determining whether power management bit of the first frame indicates that the first station device identified by the MAC address is in a power saving mode; and
responsive to determining that the power management bit of the first frame indicates that the first station device is in the power saving mode, proceeding with the exchange of messages associated with the security protocol.

16. The wireless network of claim 15, wherein the processor of the third station device is to perform operations further comprising:
receiving, after completion of the exchange of messages associated with the security protocol, a second frame identifying the MAC address of the first station device;
determining whether the power management bit of the second frame indicates that the first station device identified by the MAC address is in a power saving mode; and
responsive to determining that the power management bit of the second frame indicates that the first station device is in the power saving mode, transmitting an acknowledgment frame to the first station device.

17. The wireless network of claim 15, wherein the first frame is received from the second station device.

18. The wireless network of claim 15, wherein the power management bit indicates an active mode or a power saving mode, and wherein setting the power management bit indicates that a station device identified by the MAC address is in power saving mode and clearing the power management bit indicates that the station device identified by the MAC address is in active mode.

19. The wireless network of claim 15, wherein the request to establish the connection with the first station device includes receiving an authentication request frame and an association request frame from the first station device.

20. The wireless network of claim 15, wherein the messages that are exchanged are extensible authentication protocol over local area network (EAPOL) messages to derive encryption keys used to secure data transmissions over the connection.
